(19) United States
(12) Patent Application Publication
(10) Pub. No.: US 2019/0234618 A1
(43) Pub. Date: Aug. 1, 2019

(54) DOMESTIC APPLIANCE WITH AN ILLUMINATION DEVICE AND A COOLING CHANNEL

(71) Applicant: ELECTROLUX APPLIANCES AKTIEBOLAG, Stockholm (SE)

(72) Inventors: Fabienne Reinhard-Herrscher, Schnelldorf (DE); Angela Ziegler, Rothenberg ob der Tauber (DE); Marco Böckler, Rothenberg ob der Tauber (DE)

(21) Appl. No.: 16/312,435

(22) PCT Filed: Jun. 20, 2017
(86) PCT No.: PCT/EP2017/065111

§ 371 Date: Dec. 21, 2018

(30) Foreign Application Priority Data
Jun. 27, 2016 (EP) 16176333.9

(51) Int. Cl. F24C 15/00; F24C 15/04; F21V 29/67; F21V 3/06

(52) U.S. Cl. CPC F24C 15/008; F24C 15/006; F21Y 2115/10; F21V 29/677; F21V 3/061; F24C 15/04

(57) ABSTRACT

The present invention relates to a domestic appliance, in particular a cooking oven, comprising at least one illumination device (10) and at least one cooling channel (30). The cooling channel (30) includes an elongated portion extending inside a wall (12) of a cavity (14) of the domestic appliance. An inner sheet (28) of said wall (12) faces the cavity (14). The cooling channel (30) is connected or connectable to at least one fan (44; 46) for generating an air stream (32, 34, 36) inside said cooling channel (30). The illumination device (10) is provided for illuminating the cavity (14) of the domestic appliance and comprises at least one LED board (16) and at least one transparent panel (18, 20). At least one light emitting diode (22) is arranged at an inner side of the LED board (16) and directed to the cavity (14). A transparent inner panel (20) of the illumination device (10) faces the cavity (14) and is arranged in a cut-out of the inner sheet (28) of the wall (12). The illumination device (10) is at least partially integrated inside the elongated portion of the cooling channel (30), so that a section of said elongated portion of the cooling channel (30) is formed within or by the illumination device (10) and at least a part of the air stream (34, 36) passes through the illumination device (10) and flows along at least one side of the LED board (16).

The present invention relates to a domestic appliance, in particular a cooking oven, comprising at least one illumination device and at least one cooling channel.

The light source elements of an illumination device in the domestic appliance, in particular in the cooking oven, may be de-stroyed, if the temperature around said light source elements is too high. On the one hand a line of sight between the light source elements and the cavity is required. On the other hand a thermal shielding must exist between said light source elements and the cavity.

It is an object of the present invention to provide a domestic appliance with an illumination device for illuminating a cavity of said domestic appliance, wherein the illumination device is effectively cooled down by low complexity.

The object is achieved by the domestic appliance according to claim 1.

According to the present invention a domestic appliance, in particular a cooking oven, is provided, which comprises at least one illumination device and at least one cooling channel, wherein
the cooling channel includes an elongated portion extending inside a wall of a cavity of the domestic appliance,
an inner sheet of said wall faces the cavity,
the cooling channel is connected or connectable to at least one fan for generating an air stream inside said cooling channel,
the illumination device is provided for illuminating the cavity of the domestic appliance,
the illumination device comprises at least one LED board and at least one transparent panel,
at least one light emitting diode is arranged at an inner side of the LED board and directed to the cavity,
a transparent inner panel of the illumination device faces the cavity and is arranged in a cut-out of the inner sheet of the wall, and
the illumination device is at least partially integrated inside the elongated portion of the cooling channel, so that a section of said elongated portion of the cooling channel is formed within or by the illumination device and at least a part of the air stream passes through the illumination device and flows along at least one side of the LED board.

The core of the present invention is the geometric arrangement of the LED board and the transparent inner panel within the cooling channel. The arrangement of the inner panel in the cut-out of the inner sheet of the wall allows a closed cooling channel. The inner panel and the inner sheet of the wall form a closed separating plate between the cavity and the cooling channel and a thermal shield. At least one side of the LED board is in contact with the air stream.

In particular, the at least one transparent panel is arranged between the LED board and the cavity, wherein preferably at least one transparent panel is a glass panel.

Preferably, at least a part of the air stream passes an outer side of the inner panel, wherein preferably the inner panel is a glass panel. For example, the air stream flows between the LED board and the inner panel.

According to one example, the fan is exclusively provided for the cooling channel, wherein preferably said fan is driven by an electric motor. The fan may be separately controllable. This ex-clusive fan allows very high temperature in the cavity.

Alternatively, the fan is an exhaust fan of the domestic appliance or and a cooling fan for one or more electric or electronic circuits, wherein preferably said exhaust fan is connected to the cooling channel via a tube or a flexible pipe. In this case, a fan already present in the domestic appliance can be used for cooling the illumination device.

According to a special embodiment, the wall includes at least one embossing extending inwards, wherein the embossing forms a part of the cooling channel, so that the air stream or a part of the air stream passes at least the outer side of said embossing. By the embossing the cooling channel is produced by an easy way.

In this case, the LED board may be integrated in a cut-out of the embossing, wherein preferably the embossing is formed in an outer sheet of the wall.

Further, the wall may comprise at least one cover element for closing the embossing, wherein the air stream flows between the cover element and the embossing, and wherein preferably said cover element is removable from the wall. The cover element con-tributes to a simple construction of the cooling channel on the one hand and allows an easy access to the illumination device from the outside.

According to a preferred embodiment of the present invention, the illumination device comprises at least one transparent central panel arranged between the LED board and the transparent inner panel, wherein the air stream is subdivided into at least two partial air streams, so that an outer air stream flows between the LED board and the central panel, while an inner air stream flows between the central panel and the inner panel. The two or more partial air streams contribute to a significant re-duction of the temperature around the LED board.

For example, the transparent inner panel is a flat panel or a flat glass panel, in particular a borosilicate glass panel, wherein preferably the inner side of said transparent inner panel is coated by a transparent thermal protective layer. The borosilicate glass panel is available by low costs. The thermal protective layer provides an additional thermal shield. The transparent thermal protective layer can be a transparent heat-reflecting layer that coats the inner side of at least one of the inner panel and the outer panel. Preferably, the heat-reflective coats the inner side of only the inner panel. In alternative, the transparent heat-reflecting layer coats the inner side of only one of the inner panel or the outer panel. Still in alternative, the transparent heat-reflecting layer coats the inner sides of both the inner panel and the outer panel. Preferably, the transparent heat-reflective layer comprises a heat-reflective substance selected from at least one metal, metal oxide or a combination of at least two metals, at least two metal oxides or of at least one metal and at least one metal oxide. Suitable metal oxides comprise titanium oxides, such as e.g. titanium dioxide, and tantalum oxides. Preferably, the transparent heat-reflective layer comprises a suitably thin essentially transparent layer of said heat-reflective substance, such as a suitably thin essentially transparent layer of titanium oxide.

Alternatively, the transparent inner panel may be shaped, so that the light from the light emitting diodes is distributed in the cavity according to a predetermined manner. Thus, the light distribution in the cavity may be controlled by the properties of the inner glass panel.

Furthermore, the transparent inner panel may be formed as a glass lens, wherein preferably said glass lens includes a cavity evacuated or filled with a gaseous or liquid medium.

In this case, the cavity of the glass lens may be filled with air or an inert gas.

Additionally, at least one surface of the glass lens is provided with a transparent heat protection, wherein preferably said transparent heat protection comprises mica.

In particular, the cooling channel is arranged inside a sidewall of the cavity, wherein preferably said cooling channel extends vertically.

At last, the domestic appliance is a cooking oven, wherein the illumination device is provided for illuminating an oven cavity of said cooking oven.

Novel and inventive features of the present invention are set forth in the appended claims.

The present invention will be described in further detail with reference to the drawings, in which

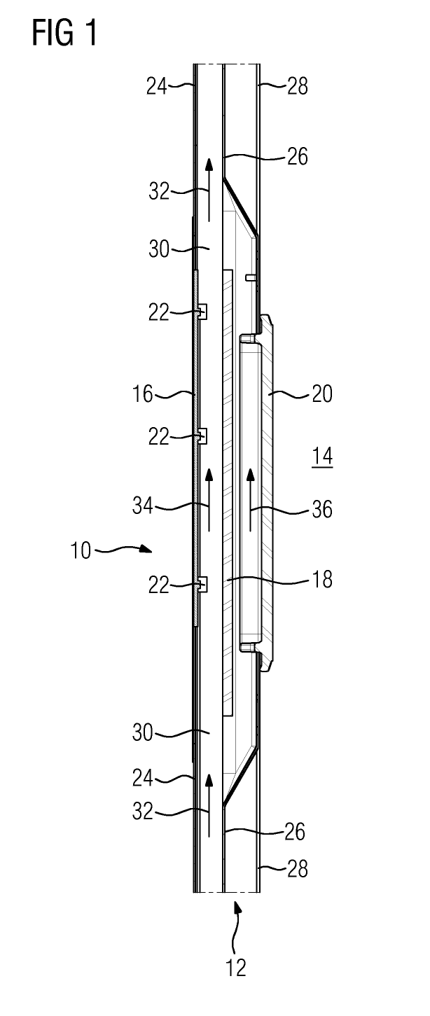

FIG. 1 illustrates a schematic sectional front view of illumination device integrated within a sidewall of an oven cavity according to a first embodiment of the present invention,

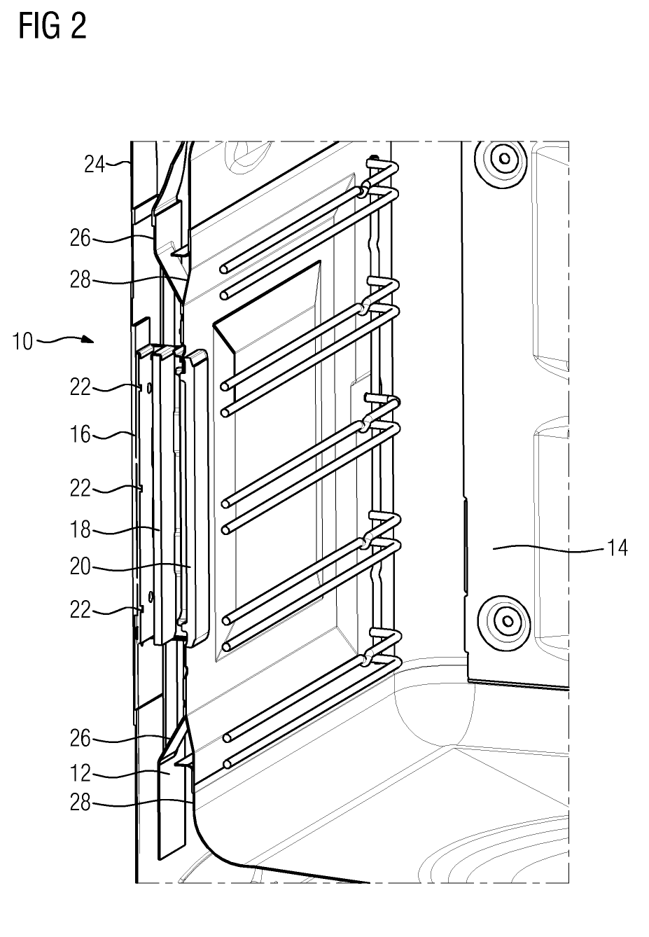

FIG. 2 illustrates a schematic sectional perspective view of the illumination device integrated within the sidewall of an oven cavity according to the first embodiment of the present invention,

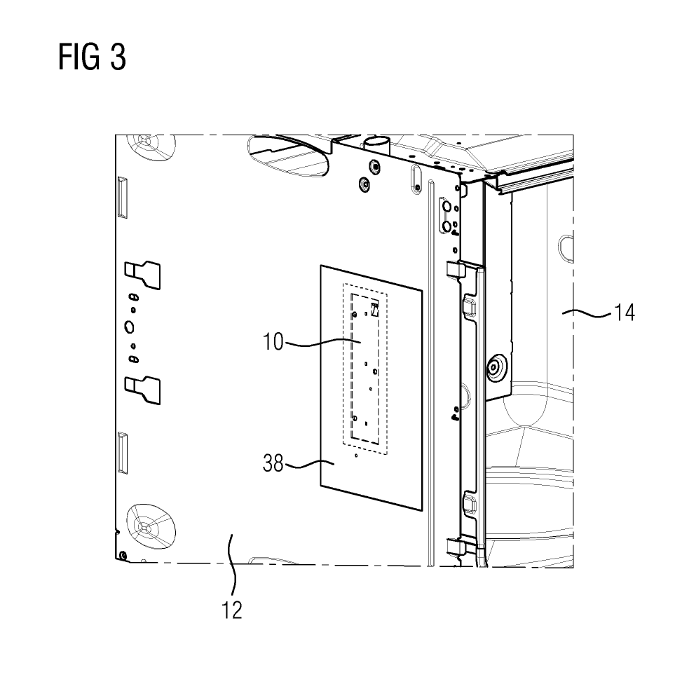

FIG. 3 illustrates a schematic perspective view of the illumination device integrated within the sidewall of the oven cavity according to a second embodiment of the present invention, wherein the illumination device is closed by a cover element,

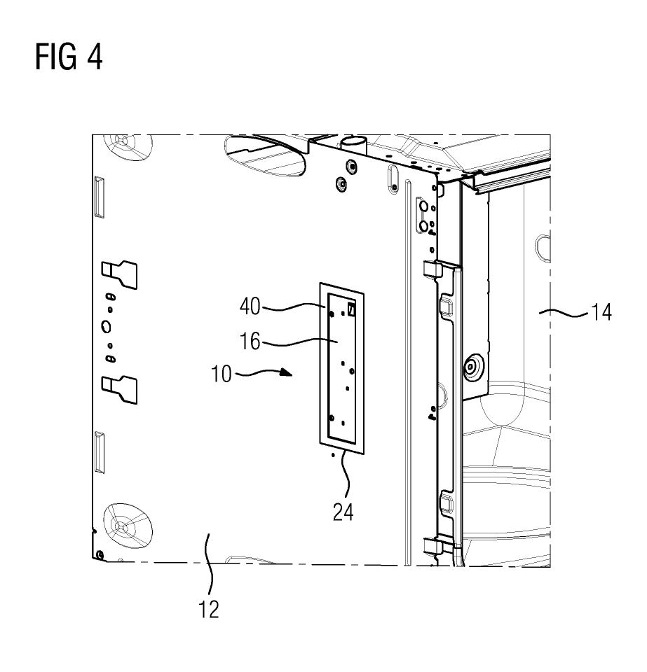

FIG. 4 illustrates a schematic perspective view of the illumination device integrated within the sidewall of the oven cavity according to the second embodiment of the present invention, wherein the cover element is removed,

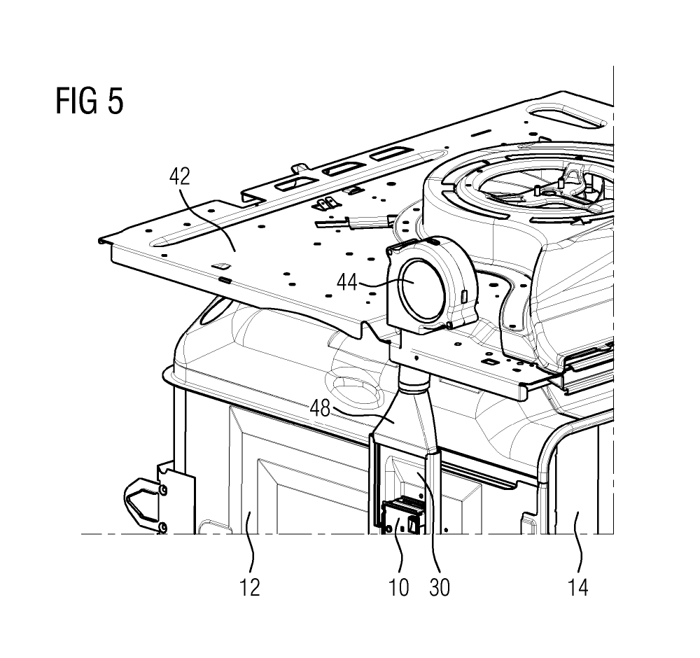

FIG. 5 illustrates a schematic perspective view of an upper part of a cooling channel for the illumination device integrated within the sidewall of the oven cavity according to a third embodiment of the present invention,

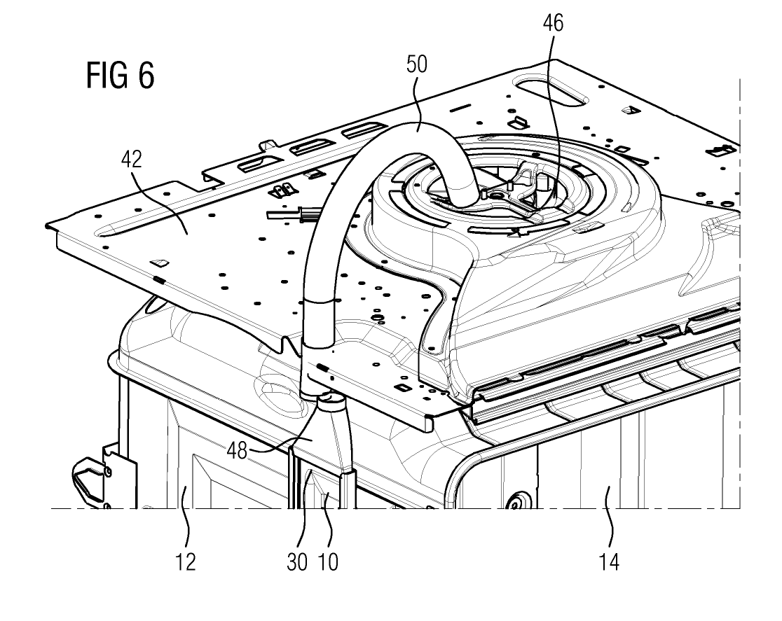

FIG. 6 illustrates a schematic perspective view of the upper part of the cooling channel for the illumination device integrated within the sidewall of the oven cavity according to a fourth embodiment of the present invention, and

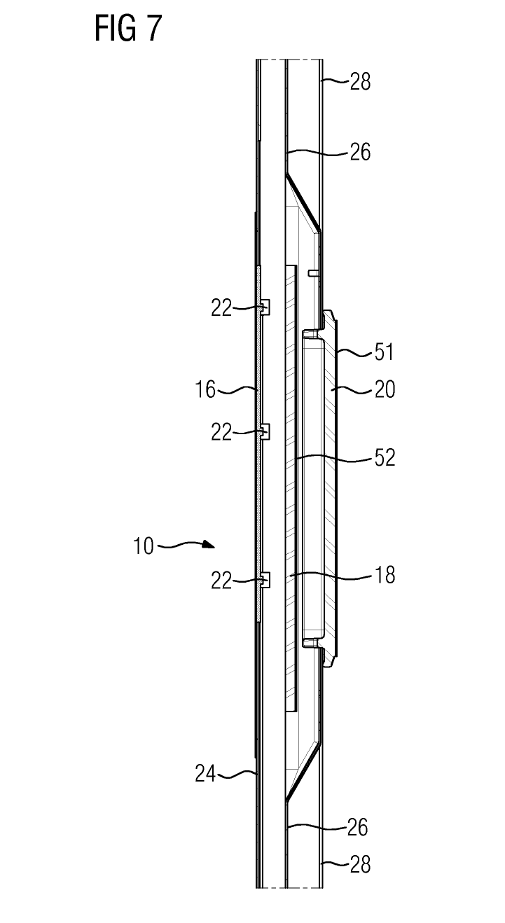

FIG. 7 illustrates a schematic sectional front view of illumination device integrated within a sidewall of an oven cavity according to a fifth embodiment of the present invention, wherein at least one of the transparent inner glass panel or the transparent central glass panel comprises a transparent heat reflecting layer.

FIG. 1 illustrates a schematic sectional front view of illumination device 10 integrated within a sidewall 12 of an oven cavity 14 according to a first embodiment of the present invention. In this example, the illumination device 10 is provided for a cooking oven and arranged within the sidewall 12 of the oven cavity 14. In general, the illumination device 10 may be provided for illuminating a cavity of an arbitrary domestic appliance. Further, the illumination device 10 may also be integrated within a top wall, rear wall and/or bottom wall of the cavity of the domestic appliance. Moreover, the illumination device 10 may be integrated within a door of the domestic appliance, in particular in an oven door of the cooking oven. In the latter case, the illumination device 10 may be arranged above, beneath and/or beside a viewing window of the door or oven door.

According to the first embodiment, the illumination device 10 is arranged within a cut-out of the sidewall 12. The illumination device 10 comprises an LED board 16, a transparent central glass panel 18 and a transparent inner glass panel 20. At least one light emitting diode (LED) 22 is arranged at an inner side of the LED board 16. In this example, a plurality of light emitting diodes 22 is arranged at an inner side of the LED board 16. The term “inner side” relates to those sides directed to the oven cavity 14. The LED board 16 forms an outer side of the illumination device 10, while the inner glass panel 20 forms its inner side. The central glass panel 18 is arranged between the LED board 16 and the inner glass panel 20. The inner glass panel 20 is in a direct contact to the oven cavity 14.

Instead of the central glass panel 18 and the inner glass panel 20, the illumination device 10 may comprise a central panel 18 and an inner panel 20, respectively, made of other transparent materials.

The sidewall 12 includes an outer sheet 24, a central sheet 26 and an inner sheet 28. The central sheet 26 is connected to the inner sheet 28 along the circumference of the cut-out of the sidewall 12. A cooling channel 30 is formed between the outer sheet 24 and the central sheet 26 of the sidewall 12. An air stream 32 flows in said cooling channel 30 bottom-up. Further, the air stream 32 passes through the illumination device 10. Thus, the illumination device 10 forms a section of the cooling channel 30. The air stream 32 is generated by an extra fan or a fan already present in the cooking oven. For example, an exhaust fan or a fan for cooling electronic circuits may be used.

In this embodiment, the air stream 32 is subdivided into two partial air streams 34 and 36 within the illumination device 10. An outer stream 34 flows between the LED board 16 and the central glass panel 18 bottom-up. In a similar way, an inner air stream 36 flows between the central glass panel 18 and the inner glass panel 20 bottom-up. The outer air stream 34 is guided directly over the light emitting diodes 22. The inner air stream 34 is guided between the both glass panels 18 and 20 and discharges heat from said glass panels 18 and 20. The transparent glass panels 18 and 20 may be constructed of standard materials. For example, the inner glass panel 20 is made of borosilicate. An expensive glass panel, e.g. a vacuum glass panel or a calcium silicate panel, is not necessary. The transparent glass panels 18 and 20 may be flat glass panels and/or structured glass panels. For example, the inner glass panel 20 may have a structure in order to distribute the light from the light emitting diodes 22 into the oven cavity 14.

Alternatively, the central glass panel 18 and the inner glass panel 20 may by formed as a single-piece part comprising openings at its top side and bottom side, so that the inner air stream 36 can pass through the intermediate space between the central glass panel 18 and the inner glass panel 20.

The light emitting diodes 22 are arranged in a heat sink of the sidewall 12. The LED board 16 and the outer sheet 24 are the coldest parts of the side wall 12 because of their distances from the oven cavity 14 on the one hand and the air outer stream 34 and the inner air stream 36 on the other hand. Further, the structure of a heat sink in the wall of the oven cavity is disclosed in EP 2 119 968 B1.

In this example, the LED board 16 is arranged parallel to the plane of the wall 12. Alternatively, the LED board 16 may be in-clined, so that the light emitting diodes 22 are directed rear-wards in order to improve the illumination of the oven cavity 14.

FIG. 2 illustrates a schematic sectional perspective view of the illumination device 10 integrated within the sidewall 12 of the oven cavity 14 according to the first embodiment of the present invention. In particular, FIG. 2 clarifies the structure of the illumination device 10 and the sidewall 12.

The illumination device 10 is arranged within the cut-out of the sidewall 12 and comprises the LED board 16, the transparent central glass panel 18 and the transparent inner glass panel 20. The light emitting diodes 22 are arranged at an inner side of the LED board 16. The LED board 16 forms the outer side of the illumination device 10, while the inner glass panel 20 forms its inner side. The central glass panel 18 is arranged between the LED board 16 and the inner glass panel 20. The inner glass panel 20 is in a direct contact to the oven cavity 14.

The sidewall 12 includes the outer sheet 24, the central sheet 26 and the inner sheet 28. The central sheet 26 and the inner sheet 28 are connected to each other along the circumference of the cut-out of the sidewall 12. Between the outer sheet 24 and the central sheet 26 of the sidewall 12 the cooling channel 30 is formed, in which the air stream 32 flows bottom-up. The air stream 32 passes through the illumination device 10.

In this special embodiment, the air stream 32 is subdivided into the outer air stream 34 and the inner air stream 36 within the illumination device 10. The outer stream 34 flows between the LED board 16 and the central glass panel 18 bottom-up, while the inner air stream 36 flows between the central glass panel 18 and the inner glass panel 20 bottom-up. The outer air stream 34 is guided directly over the light emitting diodes 22, while the inner air stream 34 discharges heat from the glass panels 18 and 20.

In a modification of the first embodiment, the inner glass panel 20 is replaced by a transparent glass lens as disclosed in EP 2 233 839 A1. Said glass lens includes a cavity. Preferably, the cavity is evacuated or filled with a gaseous or liquid medium. For example, the cavity is filled with air or an inert gas. At least one surface of the glass lens may be provided with a transparent heat protection. For example, said transparent heat protection comprises mica. The combination of the glass lens and the both air streams 34 and 36 allows a very high thermal shield. In particular, this is advantageous for a cooking oven with pyrolytic cleaning function generation temperatures up to 450° C. to 500° C.

As an alternative to the first embodiment, the illumination device 10 comprises the LED board 16 and the inner glass panel 20 only, wherein the central glass panel 18 is absent. In this case, the complete air stream 32 flows between the LED board 16 and said inner glass panel 20. Also in this case, the inner glass panel 20 may be replaced by the glass lens disclosed in EP 2 233 839 A1, which improves the thermal efficiency of the air stream 32.

FIG. 3 illustrates a schematic perspective view of the illumination device 10 integrated within the sidewall 12 of the oven cavity 14 according to a second embodiment of the present invention, wherein the illumination device 10 is closed by a cover element 38.

In this embodiment, the illumination device 10 comprises the cover element 38. Said cover element 38 is attached at the outer sheet 24 of the oven cavity 14 and covers the illumination device 10. Preferably, the cover element 38 is detachably attached at the sidewall 12 of the oven cavity 14, so that the illumination device 10 is accessible from the outside. In particular, the light emitting diodes 22 and other components of the illumination device 10 may be easily exchanged.

FIG. 4 illustrates a schematic perspective view of the illumination device 10 integrated within the sidewall 12 of the oven cavity 14 according to the second embodiment of the present invention, wherein the cover element 38 is removed.

According to the second embodiment, the sidewall 12 includes an embossing 40 extending inwards. Alternatively, the sidewall 12 may include a deep drawing instead of the embossing 40. The outer sheet 24 of the sidewall 12 is embossed inwardly. In this example, the embossing 40 has a rectangular shape. The embossing 40 is marginally bigger than the LED board 16 of the illumination device 10. The LED board 16 is attached within a cut-out of the embossing 40. A section of the cooling channel 30 is formed between the cover element 38 and the embossing 40. For this pur-pose, openings are formed in the top part and bottom part of the embossing 40. In this embodiment, an air stream 32 passes through the illumination device 10 between the cover element 38 and the LED board 16, so that the outer side of the LED board 16 is in direct contact with the air stream 32. At least one glass panel 20 is arranged at the inner side of the illumination device 10.

Further, the air stream 32 is subdivided into two partial air streams 34 and 36 within the illumination device 10. The outer air stream 34 flows between the cover element 38 on the one hand and the outer sides of the LED board 16 and the embossing 40 on the other hand. In contrast, the inner stream 36 flows between the outer sides of the LED board 16 and the embossing 40 on the one hand and the inner glass panel 20 on the other hand.

Moreover, the first and second embodiment of the present invention may be combined, so the illumination device 10 comprises the cover element 38, the embossing 40 with the LED board 16 in its cut-out, the central glass panel 18 and the inner glass panel 20. This combination results in a subdivision of the air stream 32 into three partial air streams. The outer air stream 34 flows between the cover element 38 on the one hand and the outer sides of the LED board 16 and the embossing 40 on the other hand. A central stream 36 flows between the outer sides of the LED board 16 and the embossing 40 on the one hand and the central glass panel 18 on the other hand. The inner air stream 36 flows between the central glass panel 18 and inner glass panel 20.

FIG. 5 illustrates a schematic perspective view of an upper part of the cooling channel 30 for the illumination device 10 integrated within the sidewall 12 of the oven cavity 14 according to a third embodiment of the present invention.

An upper end of the cooling channel 30 is connected to an additional fan 44 via an adapter 48. Alternatively, the cooling channel 30 may be directly connected to the additional fan 44. The adapter 48 provides a transition from a rectangular cross-section of the cooling channel 30 to a circular cross-section of the input of the additional fan 44. The cross-section of the cooling channel 30 is adjusted to the sidewall 12, so that cross-section of the cooling channel 30 is elongated along the plane of the sidewall 12 and narrow perpendicular to the plane of the sidewall 12. The adapter 48 is arranged above the cooling channel 30. In turn, the additional fan 44 is arranged above said adapter 48. The additional fan 44 is exclusively provided for generating the air stream 32 in the cooling channel 30. In this example, the additional fan 44 is arranged above a top wall 42 of the oven cavity 14. Preferably, the additional fan 44 is driven by a particular fan motor. Said fan motor can be controlled separately. The additional fan 44 allows cooling down the light emitting diodes 22 even so, if a very high temperature occurs in the oven cavity 14, e.g. during a pyrolytic cleaning process of said oven cavity 14.

The third embodiment of the present invention may be combined with the first and/or second embodiment. The illumination device 10 shown in FIGS. 1 and 2 may be arranged inside the cooling channel 30 of FIG. 5. In a similar way, illumination device 10 shown in FIGS. 3 and 4 may also be arranged inside the cooling channel 30 of FIG. 5. Moreover, the illumination device 10 according to the combination of the first and second embodiment mentioned above is integrable into the cooling channel 30 of FIG. 5. In the latter case, the air stream 32 would be subdivided into three partial air streams.

FIG. 6 illustrates a schematic perspective view of the upper part of the cooling channel 30 for the illumination device 10 integrated within the sidewall 12 of the oven cavity 14 according to a fourth embodiment of the present invention.

In this embodiment, the cooling channel 30 is connected to an exhaust fan 48 of the cooking oven via the adapter 48 and a flexible pipe 50. Instead of the flexible pipe 50 a tube may be interconnected between the adapter 48 and the exhaust fan 48. The adapter 48 provides the transition from the rectangular cross-section of the cooling channel 30 to a circular cross-section of the flexible pipe 50. The flexible pipe 50 is interconnected between the adapter 48 and an intake port of exhaust fan 48. Usually, the exhaust fan 48 exists already in the cooking oven. Thus, the cooling channel 30 according to the fourth embodiment can be realized by low complexity, since an additional fan is not required.

Also the fourth embodiment of the present invention may be combined with the first and/or second embodiment. The illumination device 10 shown in FIGS. 1 and 2 or the illumination device 10 of FIGS. 3 and 4 may be arranged inside the cooling channel 30 of FIG. 6. Furthermore, the illumination device 10 according to the combination of the first and second embodiment mentioned above is also integrable into the cooling channel 30 of FIG. 6, wherein the air stream 32 would be subdivided into three partial air streams.

FIG. 7 illustrates a schematic sectional front view of an illumination device 10 according to a fifth embodiment of the present invention which is shown as a variant of the illumination device of FIG. 1, wherein at least one of the transparent inner panel 20 or the transparent central panel 18 comprises a transparent heat-reflecting layer 51 or 52, respectively. In preferred exam-ples, the transparent heat-reflective layer 51 or 52, respectively, either coats the inner side of only the inner panel 20 or in alternative coats the inner side of only one of the inner panel 20 and the central panel 18 or still in alternative coats the inner sides of both the inner panel 20 and the central panel 18. The transparent heat-reflecting layer 51, 52 can comprise at least one of magnesium oxide or tantalum oxide as a heat-reflective substance.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 illumination device
12 sidewall
14 oven cavity
16 LED board
18 central panel, central glass panel
20 inner panel, inner glass panel
22 light emitting diode (LED)
24 outer sheet
26 central sheet
28 inner sheet
30 cooling channel
32 air stream
34 outer air stream
36 inner air stream
38 cover element
40 embossing
42 top wall
44 additional fan
46 exhaust fan
48 adapter
50 flexible pipe
51 inner glass thermal protective layer
52 central glass thermal protective layer

1. A domestic cooking oven, comprising at least one illumination device and at least one cooling channel, wherein:
the cooling channel includes an elongated portion extending inside a wall of a cavity of the cooking oven,
an inner sheet of said wall faces the cavity,
the cooling channel is connected or connectable to at least one fan for generating an air stream inside said cooling channel,
the illumination device is provided for illuminating the cavity,
the illumination device comprises at least one LED board and at least one transparent panel,
at least one light emitting diode is arranged at an inner side of the LED board and directed to the cavity,
a transparent inner panel of the illumination device faces the cavity and is arranged in a cut-out of the inner sheet of the wall, and
the illumination device is at least partially integrated at the elongated portion of the cooling channel, so that a section of said elongated portion of the cooling channel is formed within or by the illumination device and at least a part of the air stream passes through the illumination device and flows along at least one side of the LED board in use.

2. The cooking oven according to claim 1, wherein the at least one transparent panel is arranged between the LED board and the cavity.

3. The cooking oven according to claim 1, wherein at least a part of the air stream passes an outer side of the inner panel.

4. The cooking oven according to claim 1, wherein the fan is exclusively provided for the cooling channel.

5. The cooking oven according to claim 1, wherein the fan is an exhaust fan of the cooking oven and/or a cooling fan for one or more electric or electronic circuits.

6. The cooking oven according to claim 1, wherein the wall includes at least one embossing extending inwards and forming a part of the cooling channel, so that the air stream or a part of the air stream passes at least an outer side of said embossing, wherein the LED board is integrated in a cut-out of the embossing.

7. The cooking oven according to claim 6, wherein the wall comprises at least one removable cover element for closing the embossing, wherein the air stream flows between the cover element and the embossing in use.

8. The cooking oven according to claim 1, wherein the illumination device comprises at least one transparent central panel arranged between the LED board and the inner panel, in order to subdivide the air stream into at least two partial air streams, so that an outer air stream flows between the LED board and the central panel, while an inner air stream flows between the central panel and the inner panel.

9. The cooking oven according to claim 8, wherein at least one of the inner panel and/or the central panel is a flat panel or a flat glass panel wherein an inner side of at least one of said inner panel and/or said central panel is coated by a transparent thermal protective layer.

10. The cooking oven according to claim 9, wherein the thermal protective layer is a transparent heat-reflective layer coating an inner side of at least one of the inner panel or the central panel, wherein the transparent heat-reflecting layer comprises at least one of magnesium oxide or tantalum oxide.

11. The cooking oven according to claim 1, wherein the inner panel is shaped so that light from the light emitting diodes is distributed in the cavity according to a predetermined manner.

12. The cooking oven according to claim 1, wherein the inner panel is formed as a glass lens that includes a cavity evacuated or filled with a gaseous or liquid medium.

13. The cooking oven according to claim 12, wherein at least one surface of the glass lens is provided with a transparent heat protection comprising mica.

14. The cooking oven according to claim 1, wherein the cooling channel is arranged inside said sidewall of the cavity and extends vertically.

15. (canceled)

16. A cooking oven comprising an oven cavity defined by a plurality of walls, a first one of said walls comprising an illumination device for illuminating an interior of the oven cavity, and a cooling channel integrated with or disposed within said first wall configured to provide a cooling air flow to said illumination device, said illumination device being disposed within or forming a part of said cooling channel, said first wall further comprising an outer sheet remote from said oven cavity and an inner sheet in contact with said oven cavity, said illumination device comprising an LED board having an LED arranged at an inner side thereof and forming an outer side of the illumination device, a transparent inner panel made of borosilicate glass and forming an inner side of the illumination device, and a transparent central panel disposed therebetween, said transparent inner panel being in contact with said oven cavity, a first upward-directed cooling air-flow path of said cooling channel configured to guide cooling air directly over said LED being at least partially defined between said LED board and said transparent central panel, a second upward-directed cooling air-flow path of said cooling channel being at least partially defined between said transparent central panel and said transparent inner panel, said first and second cooling air-flow paths converging to a common downstream air-flow path at a location above said illumination device within said first wall.

17. The cooking oven according to claim 16, said transparent inner panel being a lens comprising a cavity filled with air or inert gas, a surface of said lens being provided with a transparent mica heat-protection layer.

18. The cooking oven according to claim 16, said illumination device being accessible from outside said cooking oven via an opening in the outer sheet of said first wall, a cover being detachably attached to said outer sheet and covering said illumination device, a third upward-directed cooling air-flow path of said cooling channel configured to guide cooling air directly over an outer side of said LED board being at least partially defined between said cover and said LED board, said third cooling air-flow path converging with said first and second cooling air-flow paths to said common downstream air-flow path above said illumination device.

19. The cooking oven according to claim 18, further comprising a dedicated fan in fluid communication with said common downstream air-flow path and arranged above a top wall of said oven cavity, said dedicated fan being operable to draw cooling air upward from a base of said first wall, through said first, second and third cooling air-flow paths, then through said downstream air-flow path.

20. The cooking oven according to claim 18, further comprising an exhaust fan for exhausting air from said cooking oven, a cooling inlet of said exhaust fan being in fluid communication with said common downstream air-flow path so that operation of said exhaust fan simultaneously exhausts said air from said cooking oven and draws cooling air upward from a base of said first wall, through said first, second and third cooling air-flow paths, then through said downstream air-flow path.
